(19) United States
(12) Patent Application Publication
(10) Pub. No.: US 2007/0107749 A1
(43) Pub. Date: May 17, 2007

(54) Process chamber cleaning method

(76) Inventor: Il-Kwon Sin, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/398,720

(22) Filed: Apr. 6, 2006

(30) Foreign Application Priority Data
Nov. 14, 2005 (KR) 2005-0108616

(51) Int. Cl. B08B 6/00; B08B 9/00; C03C 25/68; C23F 1/00

(52) U.S. Cl. 134/1.1; 134/22.1; 156/345.48; 216/58

(57) ABSTRACT

A cleaning method for a process chamber is disclosed. The process is performed following an etch process on a wafer, and thereafter comprises unloading a wafer from the process chamber, injecting a cleaning gas comprising at least one gas selected from a group of gases consisting of C, H, F, N and Cl into the process chamber, and converting the cleaning gas into plasma.

### BACKGROUND OF THE INVENTION

1. Technical Field

Embodiments of the invention relate to a cleaning method adapted for application to process chambers used during the manufacture of semiconductor devices.

This application claims the benefit of Korean Patent Application No. 10-2005-0108616 filed Nov. 14, 2005, the subject matter of which is hereby incorporated by reference in its entirety.

2. Discussion of Related Art

The evolution of contemporary semiconductor devices is characterized by decreasing size, increasing component density and faster operating frequencies. Size reductions and increased component density necessitate ever greater precision in the manufacturing processes used to fabricate the constituent semiconductor devices.

The fabrication of most semiconductor devices may be viewed in simple terms as the formation and modification of various material layers on a substrate (e.g., a silicon wafer). A complex sequence of fabrication processes is applied to form intricate geometries and very small components on the working surface of a wafer. A sequence of fabrication processes may include such processes as implantation processes adapted to implant impurity ions in a substrate or material layer, thin film deposition processes adapted to form a material film on the substrate, photolithography and etch processes adapted to pattern a material layer, and chemical mechanical polishing (CMP) processes adapted to planarize the working surface of the substrate. Various cleaning processes must also be applied to the substrate between fabrication processes in order to remove material debris, chemical resides, and other contaminates.

Various etch processes are common among the foregoing and are generally applied to pattern material layer(s). An etch process essentially removes an unwanted portion of a material film layer deposited on the substrate, thereby forming a desired material layer pattern. Etch processes may be classified as wet etch and dry etch. The term “wet etch” refers to a fabrication method adapted to pattern a material film using a chemical solution. The term “dry etch” refers to a fabrication method adapted to pattern a material film using non-solution based techniques such as those relying on a gas plasma, an ion beam, or sputtering.

Current trends corresponding to more densely integrated semiconductor devices favor the use of dry etch processes. Thus, trends may be explained by the increasing step differences (e.g., thickness profiles) between respective material layers or regions, increasing aspect ratio for various component structures, and decreasing line widths for circuit patterns. Dry etch processes provide the precision necessary to form these features.

Various metallization processes are also common within contemporary semiconductor device fabrication processes. The precision of these metallization processes often plays a critical role in determining the reliability and production yield of a semiconductor device. This is particularly true for densely integrated semiconductor devices.

A metallization process may be performed to form a conductive contact, an electrical interconnection, a wire bonding, etc. Current metallization processes often comprise an aluminum deposition process followed by a plasma based dry etching process. Indeed, such plasma based dry etching processes are widely used in the formation of semiconductor devices due to several advantages, including low power consumption requirements to generate the plasma, excellent control over ion concentration and ion energy characteristics, good selectivity between material layers film which increases process margins, and minimal damage of the working surface of the substrate.

Figures (FIGS.) 1A through 1C schematically illustrate a conventional, plasma-based metallization process for aluminum.

Referring first to FIG. 1A, an inter metal dielectric (IMD) 10 is deposited on a semiconductor substrate on which a transistor is formed. An aluminum metallization film 12 is then formed on IMD 10 by the metallization process. A photoresist layer 14 is then applied to metallization film 12.

After a photo mask (not shown) is formed, photoresist 14 is exposed and developed to yield a photoresist pattern 14 selectively exposing metallization film 12. Photoresist pattern 14 is used as a self-aligned etch mask to pattern the metallization film 12. Such patterning of metallization film 12 is accomplished using a plasma etching process performed in a conventional process chamber (e.g., a DPS plasma etching apparatus).

FIG. 1B illustrates an exemplary plasma etching process in this regard. Referring to FIG. 1B, plasma 16 is formed above photoresist pattern 14. Plasma 16 comprises a mixed cloud of positively charged (+) ions, negatively charged (−) electrons, and charge neutral radicals (*). Plasma 16 may be generated from one or more process gases (e.g., BCl3 (120 SCCM), C12 (60 SCCM), CHF3 (10 SCCM), N2 (10 SCCM), and Ar (100 SCCM)) introduced to the process chamber. In certain embodiments, plasma 16 may be generated under conditions of 1000 Watts of radio frequency (RF) power, 8 mT to 20 mT of pressure, a temperature range of 0□ to 150□, and process time ranging from 100 sec to 150 seconds.

With plasma 16 formed in the process chamber, a negative voltage is applied to a lower electrode located below the loaded wafer. In response to the negative voltage, the positive+ions in plasma 16 are pulled towards the wafer and are absorbed upon impact with the portions of metallization film 12 exposed through photoresist pattern 14. When absorbed, the positive+ions react chemically with atoms in metallization film 12 under the influence of kinetic energy imparted by the applied electric field to form a volatile compound. In this manner, the plasma etching process selectively removes the exposed portion of metallization film 12. (See, FIG. 1C).

The plasma etching of metallization film 12 inevitably results in polymer by-products formed by a chemical reaction between a process gas and the metal (e.g., aluminum). Following completion of the plasma etching process, these polymers, along with residual gases and other by-products, are generally discharged from the process chamber using a vacuum apparatus (e.g., a turbo pump). Unfortunately, some remaining polymers not discharged by the vacuum apparatus are absorbed onto portions of the process chamber (e.g., upper portions or a covering dome). These residual polymers may contaminate work pieces in subsequently performed processes and must, therefore, be removed by a competent cleaning process.

Most contemporary cleaning processes are gas based, using one or more gases like Cl2 and O2. A cleaning gas containing Cl2 and O2 may be used with good effect to remove the residual polymers provided N2 is not also present in the chamber. However, since N2 is very commonly used in metallization processes, such as those directed to the formation of aluminum, to obtain a precise profile for the formed metal layer, it is difficult to achieve acceptable cleaning results. As a result, residual polymers remaining on a dome surface after cleaning may drop onto the working surface of a subsequently processed wafer.

FIG. 2 illustrates a state where contaminate polymers 22 have dropped onto the surface a wafer 20. These contaminate particles dramatically reduce device yield for the wafers being processed. The conventional remedy to this reoccurring problem is a lengthy and expensive routine maintenance process during which the process chamber must be taken off line.

### SUMMARY OF THE INVENTION

In one embodiment, the invention provides a cleaning method for a process chamber comprising; performing an etch process on a wafer, unloading the wafer from the process chamber, and thereafter, injecting a cleaning gas comprising at least one gas selected from a group of gases consisting of C, H, F, N and Cl into the process chamber, and converting the cleaning gas into plasma.

In another embodiment, the invention provides a cleaning method for a process chamber, comprising; performing an etch process on a wafer, wherein the etch process leaves residual polymers inside the process chamber, unloading the wafer from the process chamber, injecting a cleaning gas comprising at least one gas selected from a group of gases consisting of C, H, F, N and Cl into the process chamber, converting the cleaning gas into plasma to decompose the residual polymers, and discharging the decomposed polymers from the process chamber.

### BRIEF DESCRIPTION OF THE DRAWINGS

The present invention will be described in the context of several embodiments with reference to the attached drawings in which:

FIGS. 1A to 1C are diagrams generally illustrating a conventional plasma based etch process;

FIG. 2 is a view illustrating a state where solidified polymers have dropped onto a wafer;

FIGS. 3 and 4 are related perspective and sectional views of an exemplary etching apparatus adapted to the benefits of a cleaning method according to one embodiment of the invention;

FIGS. 5A and 5B are sectional views illustrating an aluminum metallization process performed using a plasma etching apparatus;

FIG. 6 is a process flow chart illustrating a cleaning method according to an embodiment of the invention;

FIG. 7 is a graph illustrating a detection result for residual polymers using a refinery gas analyzer (RGA);

FIGS. 8A and 8B are views illustrating a surface state of a dome after being cleaned with a conventional cleaning process; and

FIGS. 9A and 9B are views illustrating a surface state of a dome after being cleaned with a process according to an embodiment of the invention.

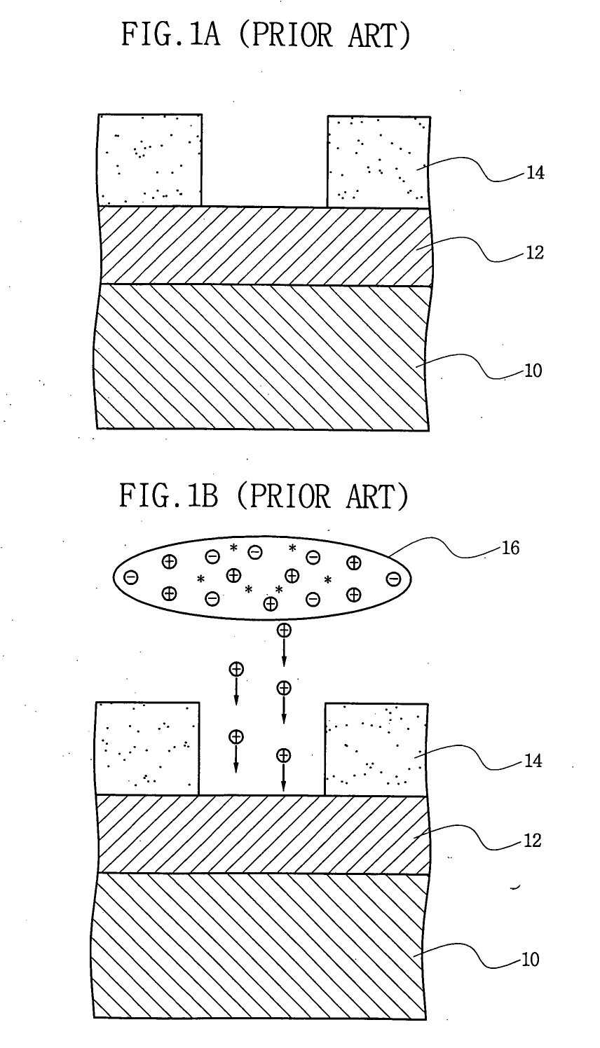

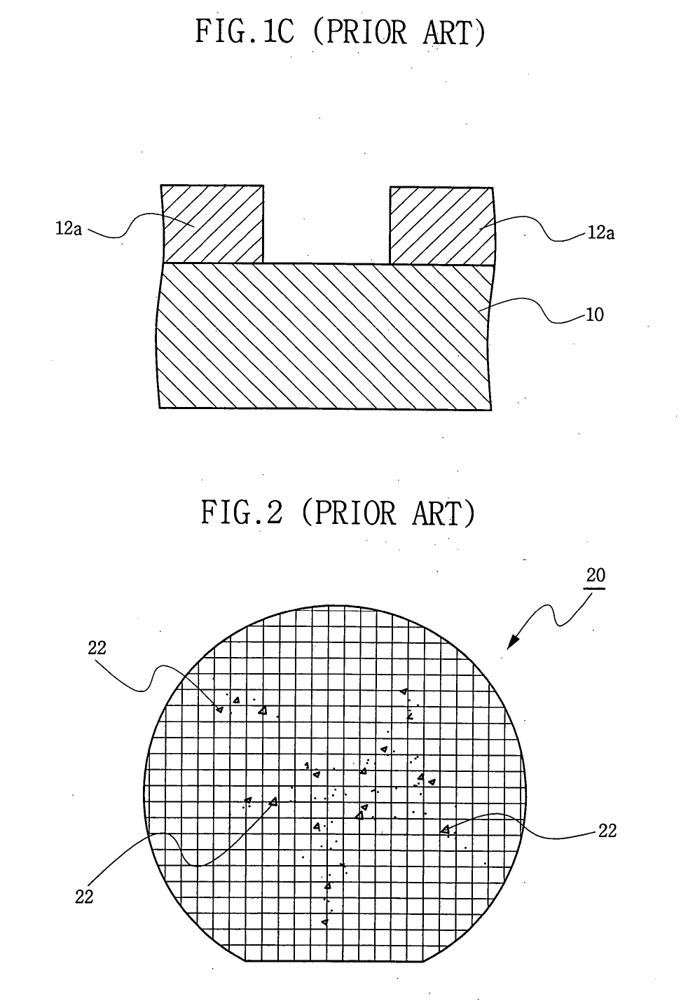

### DESCRIPTION OF EXEMPLARY EMBODIMENTS

The present invention will now be described in the context of several embodiments. However, the invention should not be construed as being limited to only the illustrated embodiments. Rather, the embodiments are presented as teaching examples.

The illustrated embodiments are drawn to techniques and related equipment adapted to perform an aluminum metallization process. However, other embodiments of the invention may be related to different equipment types and constructions as well as different metallization processes.

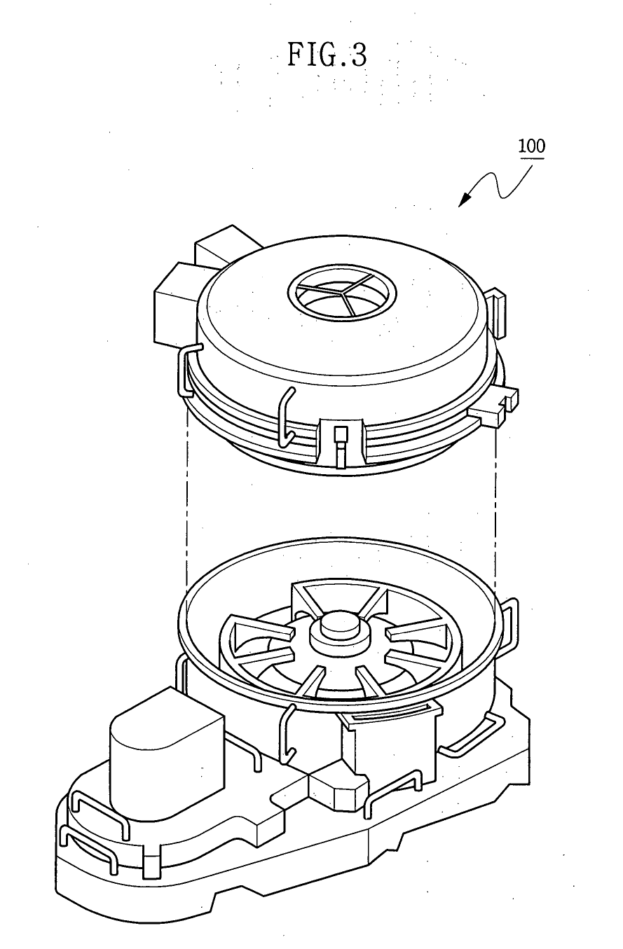

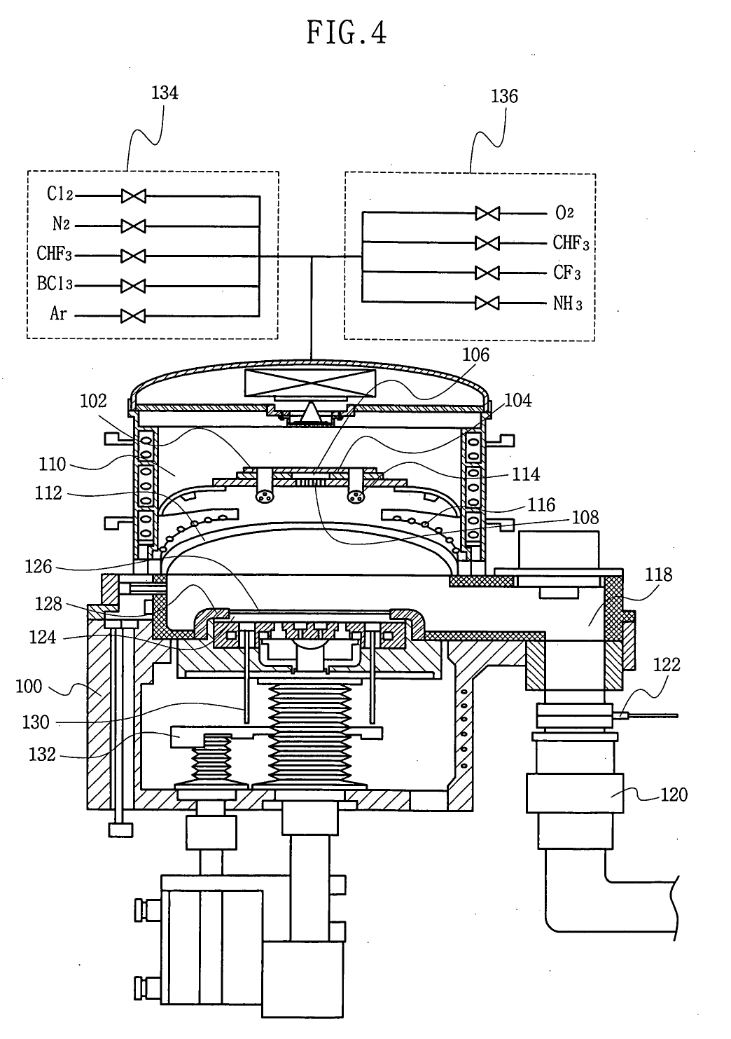

FIGS. 3 and 4 are related perspective and sectional views of a DPS plasma etching apparatus manufactured by the AMT company and adapted for use as a plasma etching apparatus. This DPS plasma etching apparatus is commonly used in metallization processes due to its advantages in independent ion concentration and ion energy control, improved process margins, and reduced wafer damage.

The exemplary DPS plasma etching apparatus comprises a process chamber 100 having a wall with constant thickness in which an etching process is performed. Process chamber 100 generally comprises an upper chamber into which process gas is introduced, and a lower chamber in which a wafer is loaded.

An upper electrode 102 is provided in the upper chamber to which RF power may be applied. In certain uses, the RF power may have a frequency of 60MHz or greater and may be effectively used to form a plasma from the process gas in process chamber 100. A shower head 104 is also provided in the upper chamber. Shower head 104 may be made of quartz or a ceramic material having excellent insulating properties and high strength. Shower head 104 is provided proximate a buffer space 106 adapted to temporarily store gas supplied through a gas supply pile and a plurality of gas injection holes 108.

In addition, a dome temp control unit (DTCU) 110 is provided on the upper chamber. The DTCU is connected to an RF power source and serves as an auxiliary chamber adapted to maintain a desired temperature in the process chamber.

Adome 112 is provided within the upper chamber. More particularly, dome 112 is installed in the DTCU to control RF power and temperature. It may be made from an insulating material or a ceramic material such as crystal, alumina or alpha alumina (sapphire). Dome 112 is provided for the purpose of more easily and quickly absorbing polymers produced during a plasma etching process to minimize wafer loss, and is formed in a semi-sphere shape as illustrated in FIG. 3. A plurality of lamps 114 is provided above dome 112 to maintaining the inside of process chamber 100 at the desired temperature. An RF coil 116 adapted to supply the RF energy power required to form the plasma is also provided above dome 112.

In addition, an exhaust line 118 is formed at one side of the upper chamber, to which line a turbo pump 120 is connected for exhausting by-products and residual gases from the inside of the process chamber. Generally, in order to perform a plasma etching process, the inside of the process chamber 100 is maintained at a certain pressure. For example, the inside of process chamber 100 may be maintained a constant vacuum state (e.g., about 0.1 mT or less) by means of turbo pump 120 connected to exhaust line 118. The vacuum control of process chamber 100 may be controlled by means of gate valve 122 provided above turbo chamber 120. In addition, a dry pump (not shown) may be connected to turbo pump 120 and used to introduce the process gas into process chamber 100 in conjunction with turbo pump 120.

The lower chamber is provided with a bottom electrode 124 to which RF power is applied and on which a chuck 126 is provided to seat a wafer. The frequency of the RF power applied to bottom electrode 124 may be about 2 MHz. A vacuum or electrostatic chuck 126 may be used. A clamp ring 128 is installed to an edge portion of chuck 126 which is formed in a loop type surrounding an edge of the wafer safely seated on chuck 126. The wafer seated on chuck 126 using ring 128 can be fixed to a certain position so that a plasma area extends to an outer portion of the wafer and then the whole area of the wafer is subject to a plasma operation. Clamp ring 128 may be made of a material with excellent strength, corrosion resistance, oxidation resistance, and heat resistance, such as SiC.

A lift 132 is provided which includes a lift pin 130 for vertically moving the wafer up and down. Lift 132 vertically moves the lift pin 130 using a driving unit, by which the wafer is moved vertically. A wafer may be loaded on chuck 126 through a wafer inlet (not shown) installed at one side of the lower chamber.

FIGS. 5A and 5B illustrate an exemplary aluminum metallization process which may be performed in the foregoing plasma etching apparatus.

Referring first to FIG. 5A, a gate electrode 210 is formed on a semiconductor substrate 200 in which an active region and a field region are divided by an isolation layer 202 by a shallow trench isolation (STI). Herein, in forming the gate electrode 210, a poly silicon layer 204 and a silicide layer 206 are sequentially deposited and patterned to have a certain area for an improvement of an electrical characteristic. An insulating layer for forming a spacer is then deposited on the whole surface of resultant object, and a anisotropic etching process such as an etch back is performed thereto to form a gate spacer 208 at the sidewalls of the poly silicon layer 204 and the silicide layer 206, finally forming the gate electrode. The silicide layer 206 may be formed with a tungsten silicide layer for more improving an electrical characteristic of the gate electrode, and the gate spacer 208 may be formed with a nitride layer.

Impurities of group □ (e.g., B) or □ (P, As) are ion-implanted into the semiconductor substrate 200 with the gate electrode 210 formed thereon, thereby forming a source and drain region (not shown). During implantation process of impurity ions, the gate electrode 210 serves as an ion implantation mask self-aligned.

A first interlayer dielectric 212 is applied on the whole surface of the resultant object with the source and drain region formed, and an etch back or a chemical mechanical polishing (CMP) is performed thereto to planarize the surface of the first interlayer dielectric 212. At this time, in order for preventing impurities implanted into the source and drain region from being diffused into other regions with a post annealing process, and preventing a profile from being damaged during the cleaning process, the first interlayer dielectric 212 may be formed with a high density plasma oxide using a chemical vapor deposition.

A photolithography and etching processes are performed to the planarized first interlayer dielectric 212 to form a buried contact hole reaching the drain region. A conductive material is deposited on the whole surface of the semiconductor substrate including the buried contact hole, to thus form a bit line 216. The bit line 216 is electrically connected with the drain region via a buried contact 214 formed by filling the conductive material into the buried contact hole. Herein, the bit line 216 may be formed by the following for increasing speed of the semiconductor device. A titanium silicide layer is formed using titanium, and a barrier layer is formed on the titanium silicide layer using a titanium nitride. A tungsten layer is formed on the barrier layer made of the titanium nitride, and a nitride layer is formed on the tungsten layer. Using the nitride layer as an etching mask, the tungsten layer, the titanium nitride layer and the titanium silicide layer are sequentially patterned to form the bit line 216.

Then, a second interlayer dielectric 218 is formed on the whole surface of the resultant object with the bit line 216 formed, using the high density plasma oxide capable of depositing at a low temperature. An etch back process or a CMP is performed thereto to planarize the upper surface of the second interlayer dielectric 218. A buried contact hole extending from the upper surface of the second interlayer dielectric 218 to the source region is formed and a conductive material is filled into the buried contact hole to form a buried contact 222. At this time, the buried contact 222 may be connected with a landing pad 220 formed on the source region in order for an alignment margin.

Subsequently, a capacitor 230 is formed which is electrically connected with the buried contact 222. The capacitor 230 consists of a bottom electrode 224, a high dielectric layer 226, and an upper electrode 228. In forming the capacitor 230, for example, a poly silicon layer is deposited and patterned to form the capacitor bottom electrode 224. Herein, the bottom electrode 224 can be realized in stack type or cylindrical type for increase of capacitance. Also, it may be realized in hemispherical grain (HSG) type like in this embodiment. Then, the high dielectric layer 226 is formed on the surface of the bottom electrode 224, and the capacitor upper electrode 228 is formed on the high dielectric layer 226, finally completing the capacitor. Herein, the high dielectric layer 226 may be formed with any one selected from a group including Ta2O5, Al2O3 by atomic layer deposition, and ONO layer of nitride-oxide-nitride laminated structure. The capacitor upper electrode 228 may be formed with poly silicon or a double-layered structure of titanium nitride and poly silicon.

Then, a third interlayer dielectric 232 is applied on the whole surface of the resultant object with the capacitor 230 formed. Contact holes 234 and 236 extending to the capacitor upper electrode 228 and the active region on the adjacent area are formed, and a conductive layer 238 is deposited thereon. Herein, the conductive layer 238 is a metal layer, for example, an aluminum layer, deposited for metallization process.

Then, a photoresist layer is coated on the conductive layer 238 composed of the aluminum for a photolithography. A photo mask (not shown) is formed on the photoresist layer, and an exposure and develop process is performed thereto to form a photoresist pattern 240.

Herein, the photoresist pattern 240 is formed for etching the underlying conductive layer 238. Accordingly, the semiconductor substrate 200 with the photoresist pattern 240 formed thereon is loaded in the DPS plasma etching apparatus illustrated in FIGS. 3 and 4 to perform a metallization process.

An exemplary metallization process performed in the DPS plasma etching apparatus illustrated in FIGS. 3 and 4 will be now described.

First, the semiconductor substrate 200 with the photoresist pattern 240 formed thereon is loaded in the process chamber 100 of the DPS plasma etching apparatus. The process gas for plasma etching is introduced into the process chamber through a process gas line 134. The process gas injected into the process chamber is for example, BCl3 (120 SCCM), Cl2 (60 SCCM), CHF3 (10 SCCM), N2 (10SCCM), and Ar (100 SCCM). A condition is then provided to convert the process gas injected into the process chamber into a plasma state. It is maintained under conditions, for example, of 1000 Watts of radio frequency (RF) power for generating plasma, 8 to 20 mT of pressure, and 0□ to 150□ of temperature. If the plasma is generated under such a process chamber atmosphere, the plasma etching process is performed for 100 sec to 150 sec of time. A chemical reaction between aluminum and the plasma particles occurs at a portion which is not covered by the photoresist pattern 240. As a result, as illustrated in FIG. 5B, an aluminum pattern 242 is formed on the semiconductor substrate 200.

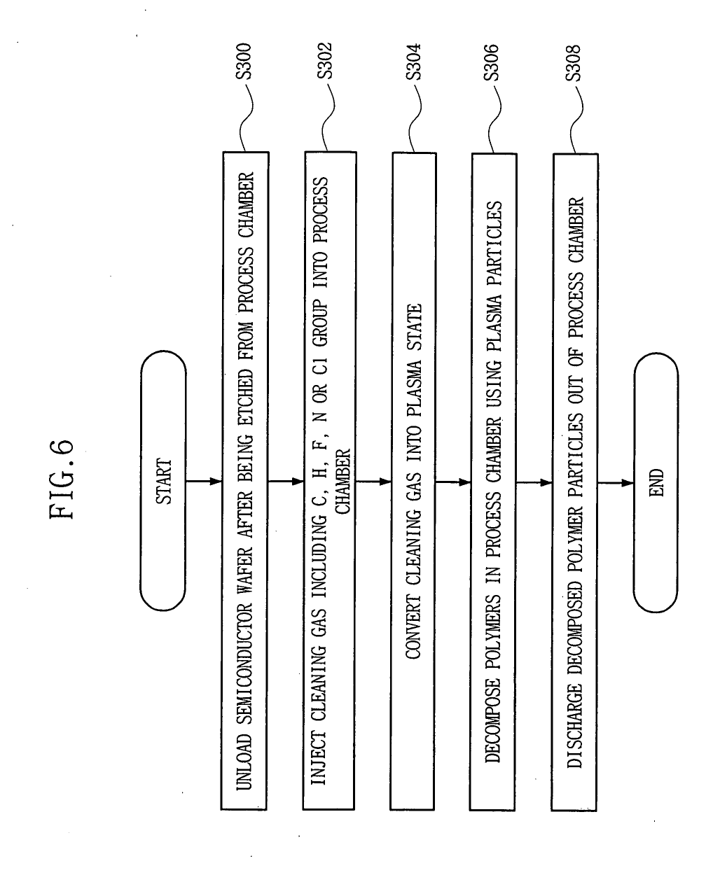

Against the technical backdrop of the foregoing examples, a cleaning method according to one embodiment of the invention will be described with reference to FIG. 6. The cleaning process may be performed, for example, after the metallization process described in conjunction with FIGS. 5A and 5B has been completed, the semiconductor wafer unloaded from process chamber (S300), and the inside of the process chamber has been exhausted using a turbo pump connected with the upper chamber.

Then, one or more process gas(es) possessing excellent cleaning properties relative to residual polymers are injected into the process chamber (S302). The “excellent cleaning properties” will exist even in the presence of N2. Thus, a cleaning gas according to embodiments of the invention include at least one gas selected from a group consisting of C, H, F, N, and Cl. More specifically, certain embodiments use CHF3+O2, CF4+O2, or NH3+O2.

With these embodiments, the CHF3, CF4, and NH3 components serve to rend the polymers into pieces to increase a surface area, and O2 serves to oxide the polymer pieces. CHF3, CF4, and NH3, and O2 may each be selectively injected into the process chamber through individual cleaning gas lines 136.

The cleaning gas injected into the process chamber is then converted into a plasma state (S304). That is, conditions within the process chamber are manipulated to convert the process gas into a plasma state. For example, possible conditions include 500 to 2000 Watts of radio frequency (RF) power, 5 to 100 mT of pressure, and/or 0□ to 150□ of temperature (as measured at the dome or chamber wall) in the process chamber. In one particular embodiment, conditions include 1000 to 1500 Watts of radio frequency (RF) power, 8 to 50 mT of pressure, and 50□ to 150□ of temperature.

If the cleaning gas is converted into the plasma under such conditions, an effective cleaning process may be performed relative to the inside of the process chamber. In the cleaning process, specifically, any residual polymers fixed to the inside of the process chamber are decomposed using the plasma particles (S306). The decomposed polymer pieces are discharged out of the process chamber using a pumping device such as a turbo pump (S308), thereby completing the cleaning process to the inside of the process chamber. Total cleaning time for certain embodiments range from 0 to 3600 seconds.

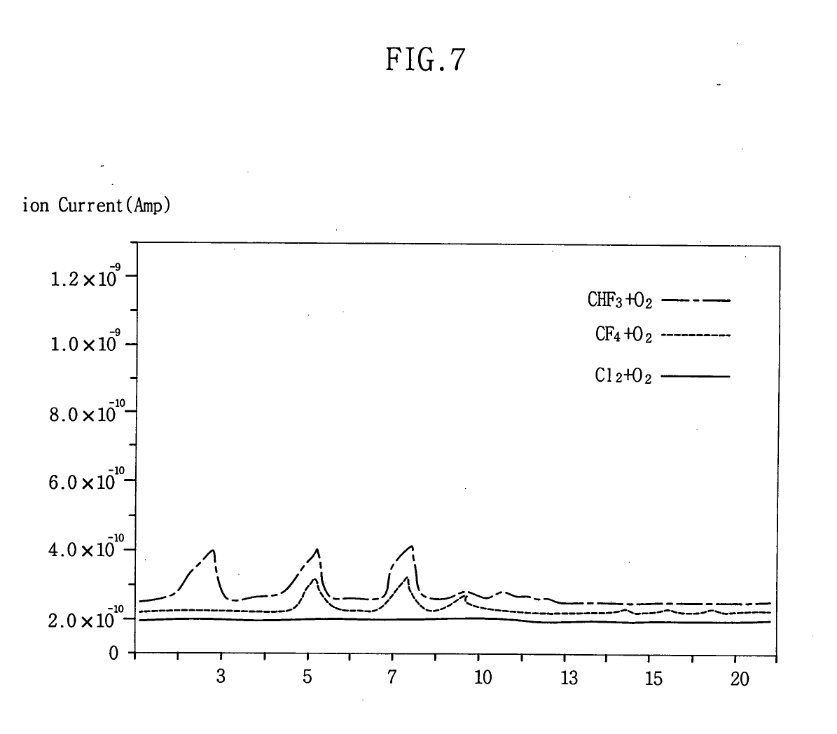

FIG. 7 is a graph illustrating analysis results for the polymer components inside of the process chamber using RGA (gas analyzer). The RGA is connected between the process chamber and the turbo pump. Thus, upon pumping the turbo pump, the gas components discharged from the inside of the process chamber is analyzed to check whether or not the polymer is detected.

Accordingly, after performing the cleaning process to the plasma etching apparatus, using the cleaning gas according to the present invention, the gas in the process chamber of the plasma etching apparatus is discharged out using the turbo pump. The gas components discharged from the process chamber are analyzed using the RGA to check whether or not the polymer is detected.

In the graph of FIG. 7, an x-axis indicates a polymer detecting time, and a y-axis indicates a quantity of the detected polymer. Graph lines L1 and L2 are the case of employing the cleaning gas according to the present invention, wherein L1 indicates a polymer detection result when using CHF3+O2, and L2 indicates a polymer detection result when using CF4+O2. Also, L3 indicates a polymer detection result when using Cl2+O2 cleaning gas used in the prior art.

As seen in the detection result of FIG. 7, when employing CHF3+O2 or CF4+O2 (L1 or L2), which is the cleaning gas according to embodiments of the present invention, a great quantity of polymers are detected by the RGA. More specifically, it can be known that when employing the cleaning gas according to the present invention, a great quantity of polymers are detected at the initial detecting by the RGA. This means that when employing the cleaning gas according to the present invention, the polymers fixed to the dome surface are decomposed and floated inside of the process chamber, and upon pumping using the turbo pump, floated polymers are discharged out of the process chamber in a great deal at one time. Although not illustrated in FIG. 7, even when employing NH3+O2, which is another cleaning gas according to the present invention, a polymer detection result can be obtained similar to L1 or L2.

On the contrary, it can be seen that when employing Cl2+O2 (L3), which had been used in the prior art, the polymer is detected a little by the detection of the RGA for the same time, relative to when employing CHF3+O2, or CF4+O2. It can be estimated that although performing the cleaning process to the process chamber, using Cl2+O2, the polymers attached to the inside of the process chamber are not decomposed so that the solidified polymers still exist onto the dome surface inside of the process chamber.

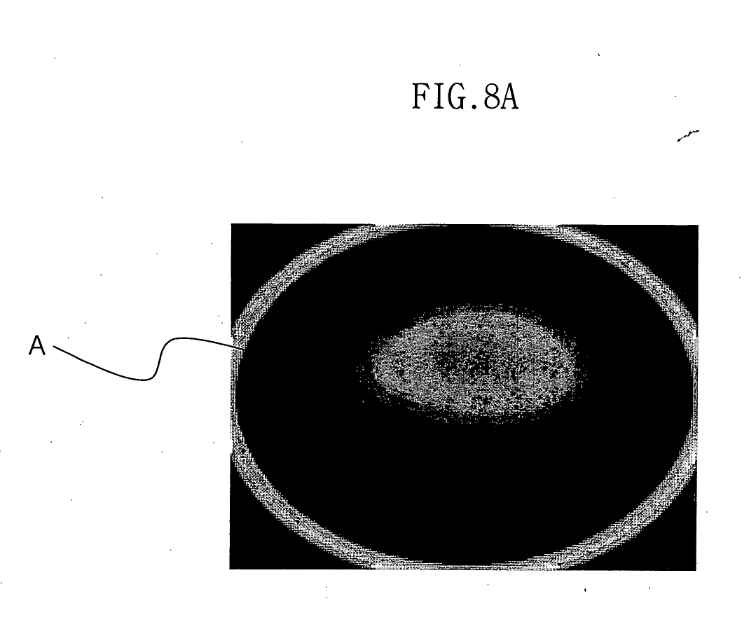

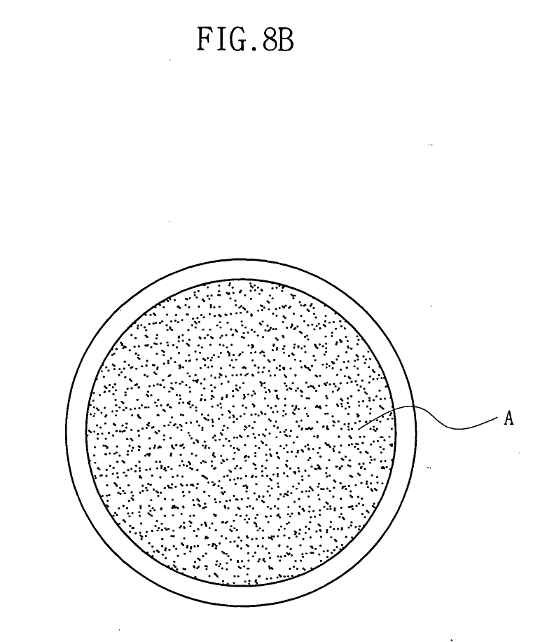

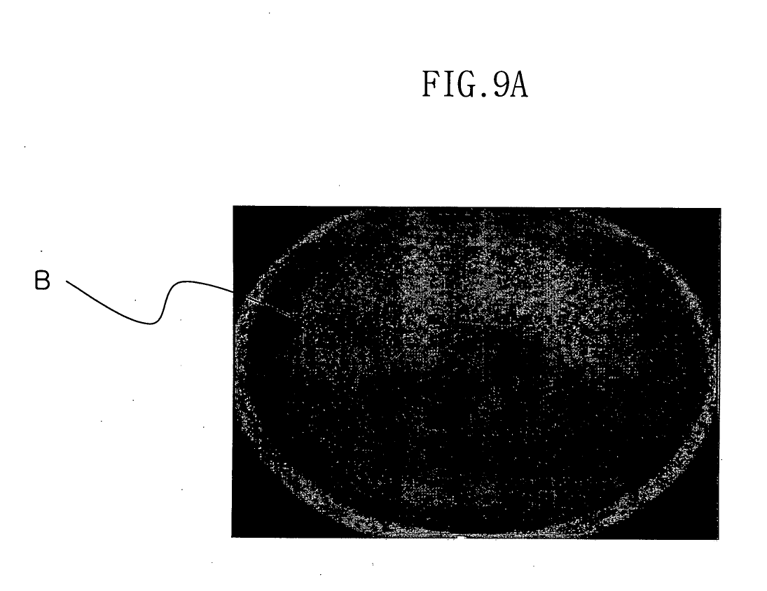

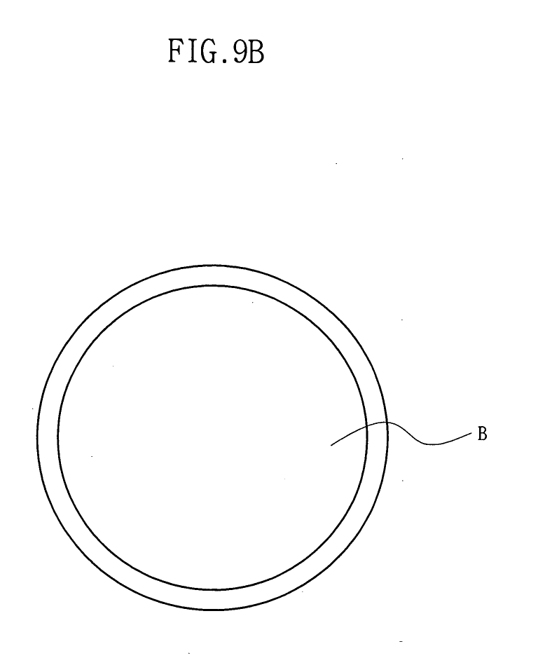

As illustrated in FIG. 7, the cleaning effect between the cleaning gas according to the present invention and that according to the prior art shows a great difference. Such practical difference of the cleaning effect can be compared and checked with reference to FIGS. 8A and 8B, and FIGS. 9A and 9B.

FIGS. 8A and 8B illustrate states of the dome surface after the completion of the cleaning process of the prior art, and FIGS. 9A and 9B illustrate states of the dome surface after the completion of the cleaning process according to embodiment of the present invention.

FIG. 8A is a photograph of the dome surface A after the cleaning process using the cleaning gas of Cl2+O2 according to the prior art, and FIG. 8B is a diagrammatic view of FIG. 8A, in which it can be seen that the polymers are still attached to the dome surface. The components seen blacky to the naked eye are solidified polymers.

On the contrary, FIG. 9A is a photograph of the dome surface B after the cleaning process using the cleaning gas according to the present invention, and FIG. 9B is a diagrammatic view of FIG. 9A, in which it can be seen that the dome surface is clean relative to FIGS. 8A and 8B. That is, the polymers attached to the dome surface are clearly removed to expose only the dome material.

This complete cleaning precludes the contamination problem noted above with respect to conventional cleaning practices.

The invention has been described in relation to several exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A cleaning method for a process chamber comprising:
performing an etch process on a wafer;
unloading the wafer from the process chamber; and thereafter,
injecting a cleaning gas comprising at least one gas selected from a group of gases consisting of C, H, F, N and Cl into the process chamber; and
converting the cleaning gas into plasma.

2. The cleaning method of claim 1, wherein the etch process is an aluminum metallization process.

3. The cleaning method of claim 1, wherein the etch process uses N2 as an etch gas.

4. The cleaning method of claim 3, wherein the etch process uses a process gas selected from a group of gases consisting of BCl3, Cl2, CHF3, N2, and Ar.

5. The cleaning method of claim 1, wherein the cleaning gas comprises at least one gas selected from a group of gases consisting of CHF3+O2, CF4+O2, and NH3+O2.

6. The cleaning method according to claim 1, wherein upon injection of the cleaning gas, the process chamber is heated to a temperature ranging from about 0 to 150□ at a pressure ranging from about 5 to 100 mT; and,
wherein the converting the cleaning gas into plasma comprises applying radio frequency (RF) power ranging from about 500 to 2000 Watts.

7. The cleaning method according to claim 6, wherein upon injection of the cleaning gas, the process chamber is heated to a temperature ranging from about 50 to 140□ at a pressure ranging from about 8 to 50 mT; and,
wherein converting the cleaning gas into plasma comprises applying radio frequency (RF) power ranging from about 1000 to 2000 Watts.

8. The cleaning method of claim 7, wherein plasma is maintained in the process for up to 3600 seconds.

9. The cleaning method of claim 1, further comprising:
forming a high vacuum state in the process chamber before injecting the cleaning gas.

10. A cleaning method for a process chamber, comprising:
performing an etch process on a wafer, wherein the etch process leaves residual polymers inside the process chamber;
unloading the wafer from the process chamber;
injecting a cleaning gas comprising at least one gas selected from a group of gases consisting of C, H, F, N and Cl into the process chamber;
converting the cleaning gas into plasma to decompose the residual polymers; and
discharging the decomposed polymers from the process chamber.

11. The cleaning method of claim 10, wherein the etch process is an aluminum metallization process.

12. The cleaning method of claim 10, wherein the etch process uses N2 as an etch gas.

13. The cleaning method of claim 12, wherein the etch process uses a process gas selected from a group of gases consisting of BCl3, Cl2, CHF3, N2, and Ar.

14. The cleaning method of claim 10, wherein the cleaning gas comprises at least one gas selected from a group of gases consisting of CHF3+O2, CF4+O2, and NH3+O2.

15. The cleaning method according to claim 10, wherein upon injection of the cleaning gas, the process chamber is heated to a temperature ranging from about 0 to 150□ at a pressure ranging from about 5 to 100 mT; and,
wherein the converting the cleaning gas into plasma comprises applying radio frequency (RF) power ranging from about 500 to 2000 Watts.

16. The cleaning method according to claim 15, wherein upon injection of the cleaning gas, the process chamber is heated to a temperature ranging from about 50 to 140□ at a pressure ranging from about 8 to 50 mT; and,
wherein the converting the cleaning gas into plasma comprises applying radio frequency (RF) power ranging from about 1000 to 2000 Watts.

17. The cleaning method of claim 16, wherein plasma is maintained in the process for up to 3600 seconds.

18. The cleaning method of claim 10, further comprising:
forming a high vacuum state in the process chamber before injecting the cleaning gas.

19. The cleaning method of claim 13, wherein the cleaning gas comprises at least one gas selected from a group of gases consisting of CHF₃+O₂, CF₄+O₂, and NH₃+O₂.
